(19) United States
(12) Patent Application Publication
(10) Pub. No.: US 2019/0024977 A1
(43) Pub. Date: Jan. 24, 2019

(54) KILN AND METHOD FOR FIRING BASIC CERAMIC ARTICLES

(71) Applicant: SACMI COOPERATIVA MECCANICI IMOLA SOCIETA' CO., Imola (IT)

(72) Inventors: Pier Francesco Vaccari, Imola (IT); Claudio Ricci, Imola (IT); Pierugo Acerbi, Imola (IT)

(21) Appl. No.: 15/961,592

(22) Filed: Apr. 24, 2018

(30) Foreign Application Priority Data
Apr. 26, 2017 (IT) 102017000045233

(51) Int. Cl. F27B 9/30; F27B 9/36; F27B 9/02

(52) U.S. Cl. CPC F27B 9/3005; F27B 2009/3638; F27B 9/028; F27B 9/36

(57) ABSTRACT

A kiln and method for firing basic ceramic articles; the kiln comprises a conveying device for conveying the basic ceramic articles along a given path through a firing chamber, in which the basic ceramic articles are heated, a cooling chamber, in which the basic ceramic articles are cooled so as to obtain ceramic products; and an extraction device adapted to generate two gas flows in the firing chamber; the gas flows come from two opposite ends of the firing chamber and meet in the extraction device.

### PRIORITY CLAIM

This application claims priority from Italian Patent Application No. 102017000045233 filed on Apr. 26, 2017, the disclosure of which is incorporated by reference.

### TECHNICAL FIELD

The present invention relates to a kiln and a method for the firing of basic ceramic articles. The present invention further relates to a plant and a method for the production of ceramic products.

### CONTEXT OF THE INVENTION

In the field of producing ceramic products, for example tiles and ceramic slabs, it is known to use plants provided with a pressing apparatus, in which basic ceramic articles are obtained starting from a semi-dry mixture (typically the humidity varies from 5% to 7%); a decoration device, which decorates the basic ceramic articles; and a sintering kiln, in which the basic ceramic articles are fired at a high temperature so as to obtain first treated articles and then the final ceramic products.

Some sintering kilns of a known type comprise a tunnel and a conveying device for conveying the basic ceramic articles along a given path through the tunnel. The tunnel comprises a pre-heating chamber, a firing chamber and a cooling chamber.

Each of these kilns also comprises a heating device to heat the basic ceramic articles during the conveying of the basic ceramic articles through the firing chamber so as to obtain treated ceramic articles. The heating device is also adapted to preheat the basic ceramic articles from room temperature to the initial temperature during the conveying of the basic ceramic articles through the preheating chamber. The kiln also comprises a cooling device adapted to cool the treated ceramic articles during the conveying through the cooling chamber; and a gas extraction device, which is adapted to extract the gases present in the tunnel at a respective extraction station. Typically, the extraction station is positioned in the area of an input station of the preheating chamber.

Operation of the extraction device determines a flow of the gases present in the tunnel. The hot gases move from the firing chamber towards the extraction station.

In some cases, the decoration device is adapted to decorate an upper surface of the basic ceramic articles (articles pressed, but not fired) by means of digital inkjet printing.

In these cases, the inks used comprise pigments, conductive polar fluids (such as water) and non-polar solvents (organic solvents; oils or other hydrocarbons).

Furthermore, the decoration device can be adapted to apply onto the basic ceramic articles, too, a ground enamel (on which the decoration is then made and) which, in some cases, comprises further non-polar components (hydrocarbons). On average, the decoration device applies from 10 g/m² to 20 g/m² of decorative ink and from 80 g/m² to 150 g/m² of enamel onto the surface of the ceramic objects.

This important quantity of non-polar solvents (organic solvents) evaporates from the basic ceramic articles, which advance through the kiln, and is partially subjected to cracking and reforming, recombining into new chemical compounds (usually smaller molecules), in part combusted and in part dragged by the flow of gas towards the first extraction station. However, the compounds, which are not completely oxidized, are undesired and require further treatments to prevent them from reaching the external environment. These newly formed chemical compounds, which are not completely oxidized, are often characterized by a strong disturbing odoriferous constitution and could also be irritant or even toxic.

One treatment, which is commonly used to reduce these problems, is afterburning of the gases collected by means of a kiln afterburner.

However, such afterburners are bulky and expensive. Furthermore, such afterburners need to process an elevated quantity of the gases produced, with evident plant, energy and maintenance costs.

It is an object of the present invention to provide a kiln and a method for firing basic ceramic articles and a plant for producing ceramic products, which allow to at least partially overcome in a forward and economical manner the drawbacks of the known art.

### SUMMARY

According to the present invention there are provided a kiln, a method and a plant according to the following independent claims and, advantageously, according to any one of the claims depending directly or indirectly on the independent claims.

### BRIEF DESCRIPTION OF THE FIGURES

The present invention will now be described with reference to the appended drawings, which illustrate some non-limiting embodiments thereof, wherein:

FIG. 1A is a schematic, side view, with parts removed for clarity, of a plant in accordance with the present invention according to a first embodiment;

FIG. 1B illustrates the temperatures present in various sections of the kiln of the plant in FIG. 1A;

FIG. 1C illustrates the pressure present in various sections of the kiln of the plant in FIG. 1A;

FIG. 2A is a schematic, side view, with parts removed for clarity, of a second embodiment of the plant in FIG. 1;

FIG. 2B illustrates the temperatures present in various sections of the kiln of the plant in FIG. 2A; and

FIG. 2C illustrates the pressures present in various sections of the kiln of the plant in FIG. 2A.

FIG. 3A is a schematic, side view, with parts removed for clarity, of a third embodiment of the plant in FIG. 1;

FIG. 3B illustrates the temperatures present in various sections of the kiln in the plant in FIG. 3A; and

FIG. 3C illustrates the pressures present in various sections of the kiln of the plant in FIG. 3A.

### DETAILED DESCRIPTION

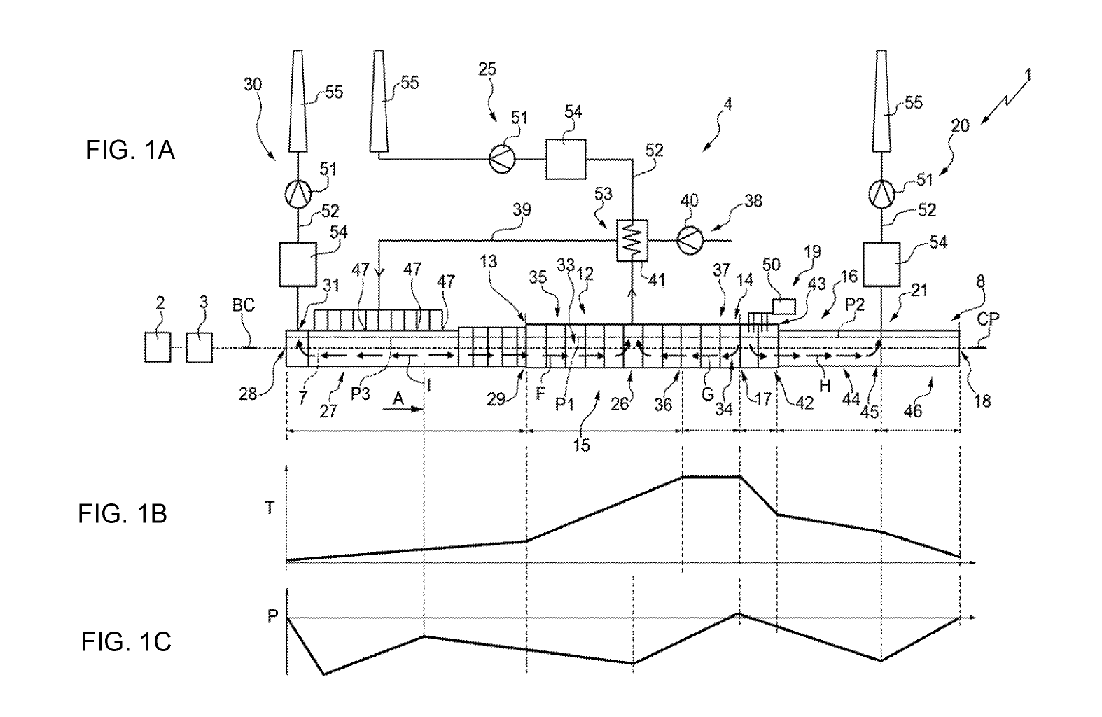

A plant for producing ceramic products CP, such as, for example tiles or ceramic slabs, is globally indicated with 1 in FIG. 1A. In particular, plant 1 is adapted to obtain basic ceramic articles BC from a semi-dry mixture; ceramic articles treated by means of a treatment (heat treatment-more precisely, firing) of the basic ceramic articles BC; and ceramic products CP by means of a further heat treatment of the treated ceramic articles, in particular, by means of cooling of the treated ceramic articles.

According to some non-limiting embodiments, plant 1 comprises a pressing apparatus 2 (known in itself and not further described) adapted to obtain basic ceramic articles

BC (known in themselves) by means of pressing a ceramic powder (a semi-dry mixture, in particular having a humidity, which varies from 5% to 7%).

Plant 1 further comprises a decoration device 3, which is adapted to apply a decoration onto the basic ceramic articles BC, in particular onto a surface (upper) of the basic ceramic articles BC; and a kiln 4 (in particular, a tunnel kiln) for the firing of the basic ceramic articles BC so as to obtain first treated ceramic articles and then (by cooling the treated ceramic articles) the final ceramic products CP.

According to some non-limiting embodiments, plant 1 comprises a drying station (known in itself and not illustrated) arranged between pressing apparatus 2 and decoration device 3.

In particular, the basic ceramic articles BC comprise ceramic powder.

Plant 1 further comprises a conveying unit adapted to convey the basic ceramic articles BC from apparatus 2 through device 3 and through at least one portion of kiln 4.

Advantageously but not necessarily, device 3 comprises at least one ink-jet head (ink-jet—known in itself and not illustrated), which is adapted to release one or more jets of ink towards the basic ceramic articles BC, in particular onto the surface of the basic ceramic articles BC, during the conveying thereof through device 3. Preferably, device is also adapted to apply, in particular before the application of the ink, a base enamel onto the basic ceramic articles BC, in particular onto the surface of the basic ceramic articles BC.

In particular, the ink comprises solid particles (inorganic pigments; for example, mixtures of chromophore metal oxides), conductive polar fluids (for example water) and non-polar solvents (organic solvents; for example oils or other hydrocarbons). The ground enamel is provided with further non-polar components (in particular, hydrocarbons).

In particular, device 3 is adapted to apply from 10 g/m² to 20 g/m² of ink and from 80 g/m² to 150 g/m² of ground enamel onto the surface of the basic ceramic articles BC. More specifically, in use, from 55% to 65% liquid components and from 35% to 45% solid components are applied onto the surface of the basic ceramic articles BC.

Therefore, the basic ceramic articles BC decorated, in use, by device 3, comprise organic compounds, in particular hydrocarbons.

Kiln 4 comprises a conveying device 7 (in particular, a roller conveyor; in particular, having a roller plane) for conveying the basic ceramic articles BC along a given path (in a feeding direction A). In particular, device 7 is part of the above-mentioned conveying unit. Device 7 is schematically illustrated in FIG. 1 by means of a dashed line.

In particular, kiln 4 (is a tunnel kiln and) presents a firing channel 8, which extends along the given path. More precisely, conveying device 7 extends at least partially within firing channel 8 for conveying the basic ceramic articles BC through firing channel 8.

Kiln 4 comprises at least one firing chamber 12 arranged along the given path and presenting an input station 13 and an output station 14; in particular, device 7 is adapted to convey the basic ceramic articles BC along a first portion P1 of the given path (which extends) from station 13 to station 14.

In particular, unless otherwise stated, when mentioning the temperature of a chamber and/or a part of a chamber, one it is referred to the temperature inside such chamber and/or a zone, measured for example using a suitable sensor (for example a thermocouple) and not to a temperature of the basic ceramic articles BC, the treated ceramic articles and the ceramic products CP.

In particular (with reference to FIG. 1B), firing chamber 12 is the part of kiln 4, which is characterized in that the internal temperatures increase (gradually) from input station 13 towards output station 14 and remain substantially constant in the area of output station 14.

In particular, the temperatures do not decrease within firing chamber 12 from input station 13 to output station 14.

According to some non-limiting embodiments, in use, the temperatures range from about 200° C. to about 400° C. in the area of station 13 and from about 1000° C. to about 1300° C. in the area of station 14.

Kiln 4 further comprises at least one heating device (only partially illustrated in FIG. 1A), which is adapted to heat the basic ceramic articles BC (from an initial temperature to a firing temperature), while the basic ceramic articles BC themselves are (conveyed) along portion P1 so as to obtain (in particular by means of firing) the treated ceramic articles.

The (main) firing of the basic ceramic articles BC to obtain the treated ceramic articles takes place in firing chamber 12.

In particular, at least a portion (for example, burners) of heating device 15 is arranged in the firing chamber 12.

With particular reference to FIG. 1B, heating device is configured to heat firing chamber 12 so that the temperatures within firing chamber 12 increase (gradually) from input station 13 towards output station 14, in particular with a gradient presenting a first value. Heating device 15 is further configured to keep the temperature substantially constant in the area of output station 14. Preferably but not necessarily, heating device 15 is also configured to ensure that the temperatures within firing chamber 12 do not decrease between input station 13 and output station 14.

Kiln 4 further comprises at least one cooling chamber 16 arranged downstream of chamber 12 along the given path and presenting an input station 17 and an output station 18; device 7 is adapted to convey the treated ceramic articles along a portion P2 of the given path from station 17 to second station 18; at least one cooling device 19 adapted to reduce the temperature of the treated ceramic articles, while the treated ceramic articles themselves are (conveyed) along portion P2 so as to obtain ceramic products CP; and a gas extraction device 25 configured to extract gas from firing chamber 12 at an extraction station 26, which is interposed between station 13 and station 14, and, in particular, to direct (convey) the gases extracted towards (to) an external environment.

With reference to FIG. 1B, cooling chamber 16 is characterized by a (continuous) lowering of the internal temperature. In particular, the internal temperature within cooling chamber 16 decreases, in use, starting from the temperature present in the area of output station 14.

Advantageously but not necessarily, kiln 4 further comprises at least one gas extraction device 20, which is adapted to extract gases present within cooling chamber 16 from chamber 16 itself at a respective extraction station 21 (interposed between station 17 and station 18), and, in particular, to direct (convey) the gases extracted towards (to) an external environment.

Advantageously but not necessarily, kiln 4 also comprises at least one preheating chamber 27, which is arranged upstream of firing chamber 12 along the given path, having a respective input station 28 and a respective output station 29.

In particular, heating device 15 is also configured to heat preheating chamber 27 so that the temperatures inside preheating chamber 27 increase (gradually) from input station 28 to output station 29 in particular with a gradient presenting a second value, which is preferably less than the first value of the gradient of the temperature of firing chamber 12. In particular, input station 13 (and also output station 29) is defined by the section, in which the change from the second value of the temperature gradient to the first value of the temperature gradient takes place.

In particular, device 7 is also adapted to convey the basic ceramic articles BC along a third portion P3 of the given path from station 28 to station 29. In particular, device 15 is further adapted to heat the basic ceramic articles BC (from a room temperature) to the initial temperature during the conveying of the basic ceramic articles BC along portion P3 (in other words, during the feeding of the basic ceramic articles BC into preheating chamber 27).

Advantageously but not necessarily, kiln 4 also comprises a gas extraction device 30 adapted to extract gases present within preheating chamber 27 at an extraction station (preheating chamber 27). In particular, station 31 is interposed between input station 28 and output station 29, more specifically in the input station 28.

Advantageously but not necessarily, firing chamber 12 and cooling chamber 16 are connected (without interruption), in particular, directly (in other words, without the interposition of further chambers and/or sections).

In particular, preheating chamber 27 is connected to firing chamber 12 (without interruption), more specifically, directly (in other words, without the interposition of further chambers and/or sections).

In other words, input station 17 is adjacent to output station 14; and input station 13 is adjacent to output station 29.

In particular, firing channel 8 is defined by firing chamber 12, by cooling chamber 16, and, advantageously but not necessarily, by preheating chamber 27.

More precisely, firing chamber 12 comprises a pre-firing section 35 extending from input station 13 to a respective intermediate station 36 of chamber 12, which station 36 is interposed between station 13 and station 14, and a firing section 37 extending from station 36 to output station 14. Preferably, extraction station 26 is interposed between input station 13 and intermediate station 36.

According to some non-limiting embodiments, heating device 15 comprises burners (of a known type and not illustrated), each of which is adapted, in particular, to give off a free flame inside firing channel 8.

More specifically, device 15 comprises burners arranged in firing chamber 12 and, advantageously but not necessarily, also in preheating chamber 27. More precisely, the burners are housed in a side wall, above and below the specified given path (even more precisely, above and below the roller plane of device 7).

Preferably but not necessarily, the density of the burners in firing chamber 12 is greater than the density of the burners in preheating chamber 27, in particular to allow higher temperatures to be obtained within firing chamber 12 than the temperatures within preheating chamber 27.

According to some non-limiting embodiments, the burners, which are arranged in firing chamber 12, in particular in pre-firing section 35 and firing section 37, are positioned along a section of firing chamber 12, which extends from a first station 33 to a second station 34. In particular, first station 33 is interposed between input station 13 and output station 14 close to station 13. In particular, close to input station 13 means that station 33 is closer to input station 13 than output station 14. In particular, second station 34 is arranged in the area of output station 14, more specifically it is interposed between first station 33 and second output station 14.

According to some non-limiting embodiments, heating device 15 is adapted, in particular the burners are adapted, to increase (gradually) the temperature of the basic ceramic articles BC during the conveying of the basic ceramic articles BC themselves between input station 13 and intermediate station 36. In particular, device 15 is adapted to create a temperature gradient within pre-firing section 35 (see FIG. 1B). More specifically, device 15 is adapted to create a temperature gradient (an increase) (in direction A) from input station 13 to output station 14 (to intermediate station 36); even more specifically, with respective lower temperatures in the area of input station 13 and respective higher temperatures in the area of output station 14.

More precisely, device 15 is adapted to keep the temperature increasing in the direction A in section 35.

Even more precisely, in use, the temperatures are from 200° C. to 400° C. in the area of station 13 and from 1000° C. to 1300° C. in the area of station 36. Device 15 is adapted to maintain such temperatures.

Advantageously but not necessarily, device 15 is adapted to keep the temperature in firing section 37 substantially constant (see FIG. 1B) in feeding direction A. In particular, the temperature in section 37 is from 1000° C. to 1300° C.

Device 15 further comprises at least one heat exchanger adapted to interact with extraction device 25, in particular to recover the thermal energy (heat) present in the gases extracted from device 25.

More specifically, exchanger 38 is adapted to reduce the temperature of the gases extracted from device 25 and heat a flow of gas, in particular a flow of air, by means of the thermal energy extracted from the gases extracted from device 25. Exchanger 38 is further adapted to introduce the heated flow of gas (air) into chamber 27 or into the burners of device 15 itself.

More specifically, in the embodiment illustrated in FIG. 1A, exchanger 38 comprises at least one main duct 39, through which the flow of gas, in particular the air flow, is directed; a fan 40 to create the flow of gas; a heat exchange element 41 adapted to extract the heat from the gases coming from the device and transfer the heat into the flow of gas; and a plurality of discharge tubes 47 to introduce the flow of heated gas into preheating chamber 27.

More precisely, chamber 16 comprises a rapid cooling section 42 extending from station 17 to a rapid final cooling station 43, interposed between input station 17 and output station 18. In particular, section 42 is directly adjacent (without interruption) to (it is immediately downstream of) firing chamber 12, more specifically directly adjacent (in other words, without the interposition of further sections and/or chambers) to output station 14.

Advantageously but not necessarily, chamber 16 also comprises an indirect cooling section 44 arranged downstream of section 42 along the given path. In particular, section 44 extends from the rapid final cooling station 43 to an indirect cooling station 45, arranged between station 43 and output station 18.

Advantageously but not necessarily, chamber 16 also comprises a final cooling area 46 arranged downstream of section 42 (more precisely, downstream of indirect cooling section 44) along the given path. In particular, section 46 extends from station 45 to output station 18.

More precisely, cooling device 19 is adapted to determine a temperature gradient in section 42; even more precisely, cooling device 19 is adapted to keep the temperature in section 42 decreasing in the direction A. In particular, the temperature at station 17 is from 1000° C. to 1300° C. (at station 17 the temperature is still substantially identical to the temperature at station 14); and the temperature at station 43 is from 500° C. to 700° C.

According to some non-limiting embodiments, cooling device 19 is further adapted to determine a temperature gradient in section 44; more precisely, cooling device 19 is adapted to keep the temperature in section 44 decreasing in direction A. In particular, the temperature at station 43 is from 500° C. to 700° C. and the temperature at station 45 is from 350° C. to 450° C.

Furthermore, device 19 is adapted to determine a temperature gradient in section 46; more precisely, cooling device 19 is adapted to keep the temperature in section 46 decreasing in direction A. In particular, the temperature at station 45 is from 350° C. to 450° C. and the temperature at station 18 is between 50° C. and room temperature (in other words, the temperature of the environment outside of kiln 4).

In particular, device 19 is configured so that the temperature gradient in section 42 presents a greater slope than the slope of the temperature gradient in section 44. Advantageously but not necessarily, the slope of the temperature gradient in section 42 is greater than the slope of the temperature gradient in section 46. In particular, device 19 is also configured so that the slope of the temperature gradient in section 46 is greater than the slope of the temperature gradient in section 44.

More precisely, cooling device 19 comprises a cooling unit 50, which is fluidically connected in the area of section 42 and adapted to direct (introduce) a cooling fluid, in particular air (cold), into chamber 16, so as to obtain the temperature gradient in section 42. Advantageously but not necessarily, unit 50 is adapted to direct the flow (of air) directly onto the (in direct contact with the) treated ceramic articles during the feeding thereof into (through) section 42. Advantageously but not necessarily, unit 50 comprises one or more blowers of a cooling fluid, in particular cold air.

Advantageously but not necessarily, device 19 also comprises a further cooling unit adapted to cool the treated ceramic articles indirectly during the feeding thereof into section 44. In particular, the further cooling unit presents micro-blowers or heat dissipating tubes.

According to some non-limiting embodiments, device 19 also comprises a further cooling unit to cool the treated ceramic articles indirectly during the feeding thereof into section 46. In particular, the further cooling unit comprises one or more blowers (of a type known in itself and not illustrated) of a cooling fluid, in particular cold air.

Advantageously, extraction device 25 is adapted to generate at least one gas flow G at least from output station 14 to extraction station 26. Preferably but not necessarily, extraction device 25 is also adapted to generate at least one gas flow F at least from input station 13 towards extraction station 26 so that the gases of flow F and the gases of flow G meet (and mix) at station 26 (to obtain a gas mixture).

In particular, the temperature at extraction station 26 is at least 400° C., in particular at least 600° C., even more particular at least 800° C. (more precisely, up to 1300° C.)

It is important to note that turbulences are created at station 26, due to the combination of flows G and F, which present local uneven temperatures.

Furthermore, such turbulences allow an improvement of the mixing between organic compounds and oxygen and an increase in the residence time of the organic compounds themselves at extraction station 26.

It has been observed experimentally that the structure according to the present invention (thus) allows an improvement in the oxidation of the organic compounds.

In this regard, note that the gases present in chamber 12 comprise organic compounds resulting from evaporation of volatile compounds, in particular non-polar solvents (hydrocarbons), present in the basic ceramic articles BC. More precisely, the non-polar solvents are components of the ink and/or ground enamel applied on the basic ceramic articles BC.

In particular, in use, the non-polar solvents (organic compounds) evaporate from the basic ceramic articles BC.

It should be noted that, in use, a greater portion of the non-polar solvents evaporates from the basic ceramic articles BC in those sections of the chamber 12 in which the temperature exceeds at least 400° C.

The evaporated organic compounds subsequently undergo oxidation. More precisely, a major portion of the organic compounds (at least 70 percent in weight, preferably at least 80 percent in weight, even more preferably at least 90 percent in weight, of the organic compounds) oxidizes before extraction from chamber 12, due to the high temperature present at extraction station 26 and/or due to the fact of being subjected to high temperatures (at least 400° C., in particular at least 600° C., even more in particular at least 800° C.) for longer periods. In particular, note that the gases of the flow G go through sections of chamber 12, which are hotter than the sections upstream of extraction station 26.

It has been observed experimentally that turbulence is created at extraction station 26 due to the meeting of flow F with flow G. This further favours complete oxidation of the organic compounds.

The gases present in firing chamber 12 also comprise the fumes from the operation of the burners of device 15 (in other words, the combustion fumes of the combustion gases).

Advantageously but not necessarily, flow F and flow G have opposite directions (paths).

In particular, device 25 comprises a suction unit 51, in particular a fan, fluidically connected to firing chamber 12 at station 26 and adapted to generate at least flow G, preferably also flow F, in particular by means of suction.

According to some non-limiting embodiments, device 25 also comprises a duct 52, connected to chamber 12 at extraction station 26, which is adapted to direct the gases extracted from chamber 12 towards (to) the external environment. More specifically, duct 52 is fluidically connected to the inside of firing chamber 12 by means of at least one opening in a wall of firing chamber 12 (in particular, in an upper wall and/or in a base wall of firing chamber 12).

Advantageously but not necessarily, suction unit 51 is arranged along duct 52.

According to some non-limiting embodiments, duct 52 is configured so as to interact with exchanger 38 at a heat exchanging station 53.

Advantageously but not necessarily, device 25 also comprises a filtering unit 54 (known as such) adapted to filter the gases extracted from firing chamber 12. In particular, unit 54 is connected to (more precisely, is arranged along) conduct 52. More specifically, unit 54 is arranged downstream of heat exchanging station 53 (and upstream of suction unit 51).

According to some non-limiting embodiments, device 25 also comprises an outlet chimney 55 fluidically connected to duct 52 to direct the gases towards the external environment (to the external environment).

Extraction device 20 is similar to device 25 and is thus described hereafter limited to the differences in relation to device 25, indicating parts, which are equal or equivalent to parts already described for device 25, with the same reference numbers.

In particular, device 20 is adapted to generate at least a gas flow H from input station 17 to extraction station 21. More specifically, flow H has an opposite direction (path) to the direction of flow G.

Device 30 is similar to device 25 (and also to device 20) and is thus described hereafter limited to the differences in relation to device 25 (and also device 30), indicating parts, which are equal or equivalent to parts already described with the same reference numbers.

In particular, device 30 is adapted to generate at least a gas flow I inside preheating chamber 27 (from the output station 29) to extraction station 31. More specifically, the flow I has an opposite direction (path) to the direction of flow F.

According to some non-limiting embodiments, kiln 4 also comprises a control unit (not illustrated) adapted to control the operation of kiln 4 itself.

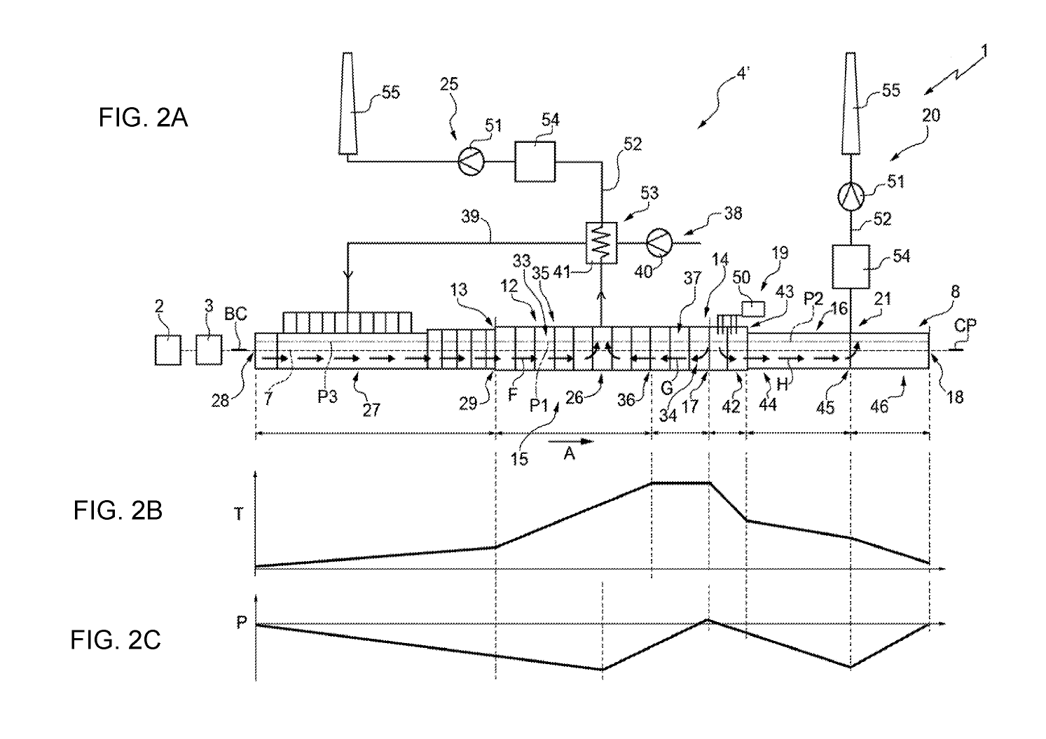

Advantageously but not necessarily, the control unit is adapted to control extraction device 30 so as to activate it and deactivate it. In particular, in use, when device 30 is active, it generates flow I (FIG. 1A); when device 30 is not active, flow I is not generated. More specifically, in use, when device 30 is not active, flow F generated by device 25 extends from input station 28 to extraction station 26 (similar situation is illustrated in FIG. 2A).

According to a further aspect of the present invention, a method is provided for producing ceramic products CP (such as, for example tiles or ceramic slabs). In particular, the ceramic products CP are obtained (from plant 1) by treating the basic ceramic articles BC. More specifically, the basic ceramic articles BC are heated (fired) to obtain treated ceramic articles and the cooling of the treated ceramic articles results in the ceramic products CP.

More precisely, the method of producing the ceramic products CP comprises at least one step of preparing the basic ceramic articles BC, at least one decoration step and at least one treatment step.

In particular, during the preparation step the basic ceramic articles BC are produced by pressing a non-compacted ceramic material (comprising ceramic powder). More specifically, the preparation step is carried out by apparatus 2.

During the decoration step at least one ink is applied, in particular by device 3, onto the basic articles, in particular onto the surface thereof. Advantageously but not necessarily, during the decoration step, a ground enamel is also applied, in particular by device 3, onto the basic ceramic articles BC, in particular onto the surface thereof. More specifically, the ground enamel is applied before the application of the ink.

The treatment step comprises the firing of the basic ceramic articles BC, in particular in kiln 4, to obtain the treated ceramic articles from whose cooling one obtains the ceramic products CP.

The method comprises also at least one transport step during which the basic ceramic articles BC are conveyed from pressing apparatus 2 to kiln 4 (through the decoration device 3).

According to a further aspect of the present invention a method for firing the basic ceramic articles BC is also provided. In particular, such method corresponds to the (is the) treatment step.

The method for firing the basic ceramic articles BC comprises: a first conveying step, during which the basic ceramic articles BC are conveyed through at least one firing chamber 12 along a portion P1 of the given path from an input station 13 to an output station 14; a heating step, during which the basic ceramic articles BC are heated (from an initial temperature to a firing temperature), while they are (conveyed) along the portion P1 so as to obtain the treated ceramic articles; a second conveying step, during which the treated ceramic articles are conveyed through at least one cooling chamber 16 along the portion P2 of the given path from input station 17 to output station 18; a cooling step, during which the temperature of the treated ceramic articles is reduced while they are conveyed along the portion P2 of the given path so as to obtain the ceramic products CP.

The method further comprises at least a first extraction step, during which the gases present in firing chamber 12 are extracted (in particular by means of device 25) from firing chamber 12 itself at extraction station 26 (interposed between first input station 13 and first output station 14).

During the first extraction step, at least gas flow G is obtained at least from output station 14 to extraction station 26.

Preferably but not necessarily, during the first extraction step, also gas flow F is obtained from at least input station 13 to extraction station 26 and the gases from gas flow F and the gases from gas flow G meet (and mix) at station 26 (obtaining a mixture of gases having a temperature of at least 400° C., in particular of at least 600° C., even more in particular of at least 800° C.). At extraction station 26 there is a temperature of at least 400° C., in particular of at least 600° C., even more in particular of at least 800° C.

Advantageously but not necessarily, the firing method also comprises at least a second gas extraction step, during which the gases present in cooling chamber 16 are extracted (in particular, by device 20) from cooling chamber 16 at extraction station 21.

More specifically, during the step of heating the organic compounds (hydrocarbons, for example solvents) they evaporate from the basic ceramic articles BC and form new organic compounds, partially oxidizing. During the heating step, the oxidation of the organic compounds is substantially completed.

During the heating step, device 15 heats (internally) firing chamber 12. More precisely, during the heating step, the burners burn combustion gas.

In particular, during the heating step in section 35 the temperature increases (a temperature gradient is created) from input station 13 to intermediate station 36.

According to some non-limiting embodiments, the temperature is kept from 200° C. to 400° C. at station 13 and from 1000° C. to 1300° C. at station 36. Furthermore, during the heating step, a substantially constant temperature is set in firing section 37, in particular from 1000° C. to 1300° C.

Advantageously but not necessarily, the heating step comprises a sub-step of heat exchange. In particular, during the sub-step of heat exchange, thermal energy is extracted (by means of exchanger 38) from the gases removed from chamber 12 (in particular, during the first extraction step) so as to heat a flow of a fluid (air), which, advantageously but not necessarily, is introduced into preheating chamber 27 or into the burners of device 15.

According to some non-limiting embodiments, during the cooling step, chamber 16 is cooled, in particular, heat is removed from the inside of chamber 16. In particular, the cooling step comprises a sub-step of rapid cooling, during which a temperature gradient is generated within section 42. More specifically, there is a temperature from 1000° C. to 1300° C. at station 17 and a temperature from 500° C. to 700° C. at station 43.

Advantageously but not necessarily, during the sub-step of rapid cooling, a cooling fluid (in particular air) is directed into section 42. In some cases, during the sub-step of rapid cooling, the cooling fluid is directed towards (against) the basic ceramic articles BC, in particular onto the surface of the basic ceramic articles BC.

According to some non-limiting embodiments, the cooling step also comprises a sub-step of indirect cooling (in particular, carried out after the sub-step of rapid cooling), during which the treated ceramic articles are cooled indirectly (and slowly) within section 44, in particular, using mini-blowers and/or heat dissipating pipes.

According to some non-limiting embodiments, the cooling step also comprises a sub-step of final cooling (in particular, carried out after the sub-step of indirect cooling), during which the treated ceramic articles are cooled by introducing cooling fluid (in particular cold air) into section 46.

More precisely, during the first extraction step, unit 51 is activated to obtain at least gas flow G, preferably also gas flow F. In particular, by means of activating unit 51 the gases are removed (by suction) from chamber 12 and directed towards the external environment.

During the first extraction step, a sub-step of filtering is also carried out, during which the gases extracted from firing chamber 12 are filtered, in particular, into unit 54.

Typically, due to the extraction of gases from kiln 4, during operation of kiln 4 (in particular, due to the extraction of gases from firing chamber 12 and from cooling chamber 16) a pressure profile is obtained in kiln 4, as illustrated in FIG. 1C. The pressure falls from input station 28 in the direction A until a first intermediate section of preheating chamber 27, after which it begins to rise and then falls again until extraction station 26; the pressure increases from station 26 to output station 14 and falls from station 14 to extraction station 21; the pressure rises again from station 21 to output station 18.

Advantageously but not necessarily (during the treatment step), a third conveying step is comprised during which the basic ceramic articles BC are conveyed through preheating chamber 27, along portion P3 of the given path from input station 28 to output station 29. A further heating step is also comprised during which the basic ceramic articles BC are heated from a room temperature to an initial temperature as they advance along portion P3. According to some non-limiting embodiments, a third gas extraction step is also comprised, during which gases present within preheating chamber 27 are extracted from chamber 27 itself.

In particular, the flow I is generated during the second extraction step.

Advantageously but not necessarily, the firing method of the basic ceramic articles BC and the method for producing ceramic products CP are implemented by kiln 4 (or 4′ or 4″) and by plant 1, respectively.

An alternative and advantageous embodiment of a kiln according to the present invention is indicated with number 4′ in FIG. 2A. Kiln 4′ is similar to kiln 4 and is thus described hereafter limited to the differences in relation to kiln 4, indicating parts, which are equal or equivalent to parts already described for kiln 4.

In particular, kiln 4′ differs from kiln 4 in that it does not comprise device 30. In this embodiment, gas flow F substantially extends from input station 28 to extraction station 26. Furthermore, the operation of kiln 4′ is similar to the operation of kiln 4 with the difference that a flow I is not generated.

In this case (FIG. 2C), the pressure falls from input station 28 to intermediate station 26, rises from station 26 to output station 14, falls from station 14 to extraction station 21 and rises again from station 21 to output station 18.

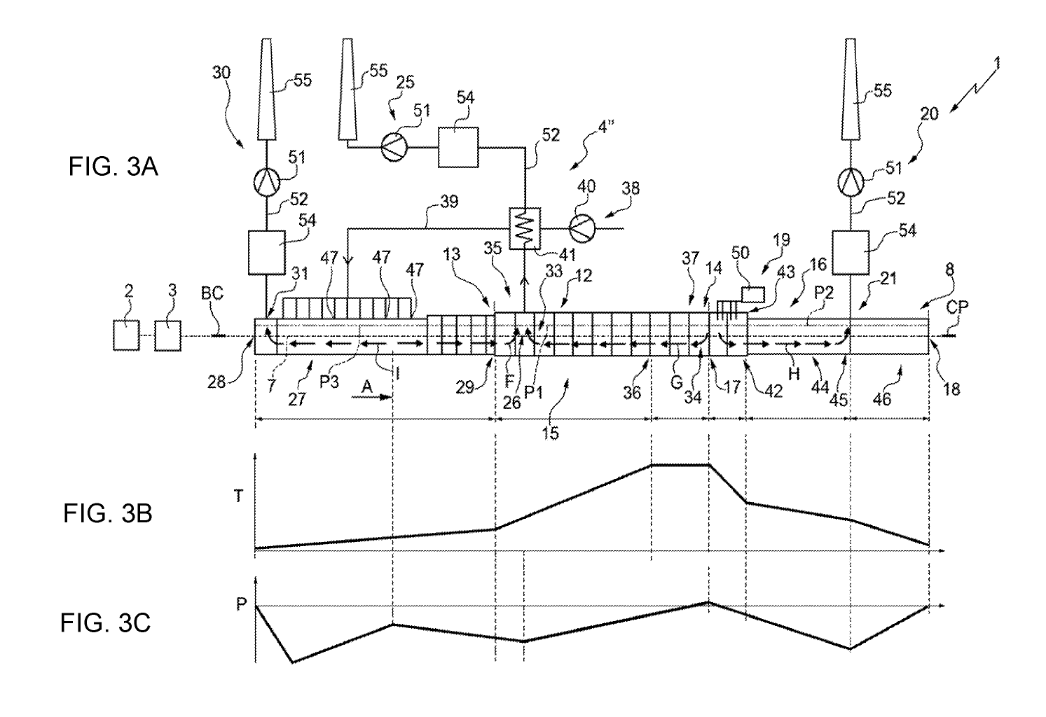

An alternative and advantageous embodiment of a kiln according to the present invention is indicated with number 4″ in FIG. 3A. Kiln 4″ is similar to kiln 4 and is thus described hereafter limited to the differences in relation to kiln 4, indicating parts, which are equal or equivalent to parts already described for kiln 4 with the same reference numbers.

In particular, kiln 4″ differs from kiln 4 in that station 26 is arranged within firing chamber 12, in particular within section 35, in the proximity of (in the area of) station 13. In particular, in the proximity of input station 13 means that extraction station 26 is closer to input station 13 than to output station 14.

In particular, extraction station 26 is arranged in a section of firing chamber 12, in which section the temperature is from 500° C. to 800° C., in particular from 600° C. to 800° C. More specifically, such section is arranged in pre-firing section 35.

In the non-limiting embodiment illustrated in FIG. 3A, a greater portion of the organic compounds evaporates, in use, in a section of chamber 12 arranged downstream of station 26. In particular, this happens due to the higher temperatures present in this section.

The applicant has found that this embodiment allows the organic compounds present in flow G to be exposed to temperatures of at least 400° C., preferably of at least 600° C., for longer, thus favouring oxidation of the organic compounds. In particular, the positioning of the extraction station 26 in the proximity of (in the area of) input station 13 allows the distance between station 26 and output station 14 to be maximized.

In a further embodiment, which is not illustrated, the kiln is similar to kiln 4′ with the difference that the station 26 is arranged as in the case of kiln 4″; in other words, station 26 is arranged in firing chamber 12, in particular, in section 35, at station 13, in particular, in a section, where the temperature is from 500° C. to 800° C., in particular, from 600° C. to 800° C.

Kilns 4, 4′ and 4″, plant 1, the method for producing ceramic products CP and the method for firing basic ceramic articles BC described above (according to the present invention) present several advantages with respect to the state-of-the-art.

In particular, the use of large afterburners is not required. In this regard, note that most of the new organic compounds are oxidized at extraction station 26, when the flows G and F meet. This allows a reduction in the costs of the kilns, system costs, energy costs and maintenance.

Note that kiln 4′ presents lower risks (compared to kiln 4) of operational instability and the emission of malodorous (or potentially harmful) products. In this regard, note that if the working of extraction devices 30 and 25 were to be regulated incorrectly in kiln 4 and device were to override device 25, a part of the organic compounds not completely oxidized could come out of kiln 4 and be released into the atmosphere.

According to some non-illustrated embodiments, the extraction device 25 also comprises an afterburner adapted to carry out further heat treatment of the gases extracted from chamber 12, in particular, to reduce further traces of organic compounds, not completely oxidized, possibly still present in the gases extracted from the firing chamber 12. However, such afterburner is significantly smaller than the afterburners, which should be used in conjunction with the kilns currently known for firing basic ceramic articles BC. An afterburner used with extraction device 25 is smaller since the quantity and/or concentration of the new organic compounds is lower due to the additional oxidation of the gas mixture in extraction station 26.

A kiln provided with an extraction device 25 and a small afterburner would nonetheless be advantageous in terms of construction costs, energy costs and maintenance costs. Nonetheless, the preferred embodiments comprise that kiln 4, in particular device 25, is not provided with an afterburner.

1. A kiln for the firing of basic ceramic articles comprising organic compounds, the kiln comprising:
a conveying device for conveying the basic ceramic articles and treated ceramic articles along a given path;
at least one firing chamber, which is arranged along the given path and has a first input station and a first output station; the conveying device is adapted to convey the basic ceramic articles along a first portion of the given path from the first input station to the first output station;
at least one heating device, which is adapted to heat the basic ceramic articles while the basic ceramic articles are along the first portion of the given path, so as to obtain the treated ceramic articles;
at least one cooling chamber, which is arranged downstream of the firing chamber along the given path and has a second input station and a second output station; the conveying device is adapted to convey the treated ceramic articles along a second portion of the given path; the second portion extending from the second input station to the second output station;
at least one cooling device, which is adapted to reduce the temperature of the treated ceramic articles while they are along the second portion, so as to obtain ceramic products;
at least one first gas extraction device, which is adapted to extract gas from the firing chamber in the area of a first extraction station, which is interposed between the first input station and the first output station and is adapted to direct the extracted gas towards an external environment;
wherein the first extraction device is adapted to generate a first gas flow from at least the first input station towards the first extraction station and a second gas flow from at least the first output station to the first extraction station, so that the gases of the first gas flow and the gases of the second gas flow meet in the area of the first extraction station, in whose area there is a temperature of at least 400° C.

2. The kiln according to claim 1, wherein the first extraction device comprises a suction unit, which is fluidically connected to the firing chamber in the area of the first extraction station and is adapted to generate the first gas flow and the second gas flow, wherein the first gas flow has a first direction and the second has flow has a second direction, which is opposite to the first direction.

3. The kiln according to claim 1, further comprising at least one second gas extraction device, which is adapted to extract gas from the cooling chamber in the area of a second extraction station;
wherein the second extraction device is adapted to generate a third gas flow from the second input station to the second extraction station.

4. The kiln according to claim 1, wherein the firing chamber (12) comprises a pre-firing section extending from the first input station to a first intermediate station of the firing chamber, being arranged between the first input station and the first output station;
the heating device is adapted to increase the temperature of the basic ceramic articles during advancement between the first input station and the first intermediate station, in particular the heating device is adapted to keep the temperature of the pre-firing section increasing in a feeding direction of the basic ceramic articles along the given path;
the first extraction station is interposed between the first input station and the first intermediate station;
wherein the firing chamber also comprises a firing section extending from the first intermediate station to the first output station of the heating chamber and the heating device is adapted to keep the temperature of the firing section substantially constant in the feeding direction between 1000° C. and 1300° C.

5. The kiln according to claim 1, comprising at least one pre-heating chamber, which is arranged upstream of the firing chamber along the given path and has a third input station and a third output station;
the conveying device is adapted to convey the basic ceramic articles along a third portion of the given path from the third input station to the third output station;
the heating device is further adapted to heat the basic ceramic articles from a room temperature to the initial temperature while the basic ceramic articles are being conveyed along the third portion;
the kiln further comprises at least one third gas extraction device, which is adapted to extract gases from the pre-heating chamber in the area of a third extraction station of the pre-heating chamber and a control unit, which is adapted to control the third extraction device so as to activate and deactivate the third extraction device.

6. The kiln according to claim 1, wherein the first extraction station is arranged in the area of the first input station.

7. The kiln according to claim 6, wherein the first extraction station is arranged in a stretch of the firing chamber in which the temperature is between 500° C. and 800° C.

8. A plant for the production of ceramic products starting from basic ceramic articles, the plant comprising:
a decoration unit adapted to decorate the basic ceramic articles with an ink comprising organic compounds, and
the kiln according to claim 1.

9. A method for the firing of basic ceramic articles comprising organic compounds, the method comprises:
a first conveying step, during which the basic ceramic articles are conveyed through at least one firing chamber along a first portion of the given path from a first input station to a first output station;
a heating step, during which the basic ceramic articles are heated while they are along the first portion of the given path, so as to obtain treated ceramic articles;
a second conveying step, during which the treated ceramic articles are conveyed through at least one cooling chamber along a second portion of the given path from a second input station to a second output station of the cooling chamber;
a cooling step, during which the temperature of the treated ceramic articles is reduced while they are along the second portion of the given path, so as to obtain ceramic products;
at least one first gas extraction step, during which gases present in the firing chamber are extracted from the firing chamber in the area of a first extraction station interposed between the first input station and the first output station;
wherein during the first extraction step, there is the production of a first gas flow from the first input station to the first extraction station and of a second gas flow from the first output station to the first extraction station;
wherein during the first extraction step, the gases of the first gas flow and the gases of the second gas flow meet in the area of the first extraction station, in whose area there is a temperature of at least 400° C.

10. The method according to claim 9, further comprising at least one second gas extraction step, during which gases present in the cooling chamber are extracted from the cooling chamber in the area of a second extraction station;
wherein during the second extraction step, there is the production of a third gas flow from the second input station to the second extraction station.

11. The method according to claim 9, further comprising:
a third conveying step, during which the basic ceramic articles are conveyed through at least one pre-heating chamber along a third portion EP of the given path from a third input station to a third output station;
a further heating step, during which the basic ceramic articles are heated from a room temperature to an initial temperature while they are being fed along the third portion of the given path; and
a third gas extraction step, during which gases are extracted from the pre-heating chamber.

12. The method according to claim 9, wherein the first extraction station is arranged in the area of the first input station in a stretch of the firing chamber in which the temperature is between 500° C. to 800° C.

13. A kiln for the firing of basic ceramic articles comprising organic compounds, the kiln comprising:
a conveying device for conveying the basic ceramic articles and treated ceramic articles along a given path;
at least one firing chamber, which is arranged along the given path and has a first input station and a first output station;
the conveying device is adapted to convey the basic ceramic articles along a first portion of the given path from the first input station to the first output station;
at least one heating device, which is adapted to heat the basic ceramic articles while the basic ceramic articles are along the first portion of the given path, so as to obtain the treated ceramic articles;
at least one cooling chamber, which is arranged downstream of the firing chamber along the given path and having a second input station and a second output station; the conveying device is adapted to convey the treated ceramic articles along a second portion of the given path; the second portion extending from the second input station to the second output station;
at least one cooling device, which is adapted to reduce the temperature of the treated ceramic articles while they are along the second portion, so as to obtain ceramic products;
at least one first gas extraction device, which is configured to extract gas from the firing chamber in the area of a first extraction station, which is interposed between the first input station and the first output station and in the proximity of the first input station; and to direct the extracted gas towards an external environment;
wherein the first extraction device is adapted to generate a first gas flow from at least the first output station to the first extraction station;
wherein in the area of the first extraction station there is a temperature of at least 400° C.

14. The kiln according to claim 13, wherein the first extraction station is arranged in a stretch of the firing chamber in which there is a temperature between 500° C. and 800° C.

15. A plant for the production of ceramic products starting from basic ceramic articles, the plant comprising:
a decoration unit adapted to decorate the basic ceramic articles with an ink comprising organic compounds, and
the kiln according to claim 13.
